(19) United States
(12) Patent Application Publication
(10) Pub. No.: US 2020/0005273 A1
(43) Pub. Date: Jan. 2, 2020

(54) Authentication Device & Related Methods

(71) Applicants: Licentia Group Limited, Cardiff (GB); MyPinPad Limited, Cardiff (GB)

(72) Inventor: Justin Pike, Blackwood (GB)

(73) Assignees: Licentia Group Limited, Cardiff (GB); MyPinPad Limited, Cardiff (GB)

(21) Appl. No.: 16/569,194

(22) Filed: Sep. 12, 2019

Related U.S. Application Data
(63) Continuation of application No. 14/761,110, filed on Jul. 15, 2015, now abandoned.

(30) Foreign Application Priority Data
Jan. 18, 2013 (GB) 1300923.8
Dec. 5, 2013 (GB) 1321505.8

(51) Int. Cl. G06Q 20/32; G06Q 20/40

(52) U.S. Cl. CPC G06Q 20/3226; G06Q 20/4012

(57) ABSTRACT

The invention provides a portable device for input of a Personal Identification Code (PIC). It comprises a card reading component and a touch screen. The screen is arranged and configured to display a pinpad and receive a PIC upon entry by a user via the pinpad. The card reading component and the touch screen are integral to the input device. The device can comprise a mobile phone, which may have a camera. The device can be a handheld card payment terminal for use in financial transactions, where a user's PIN must be authenticated. A security mechanism may be used with the device wherein an image of a scrambled keypad is displayed over an operable keypad, this enabling the device to store an encoded version of the user's input. As the user's real PIN is never stored in the device, no bank session key needs to be stored or encrypted. This enables the terminal to be produced at a lower cost then prior art arrangements.

### CROSS-REFERENCE TO RELATED APPLICATIONS

This application is a continuation of U.S. patent application Ser. No. 14/761,110, filed Jul. 15, 2015, which is the national stage of International Patent Application No. PCT/GB2014/050034, filed on Jan. 7, 2014, and which claims priority to British Patent Applications Nos. GB 1300923.8, filed on Jan. 18, 2013, and GB 1321505.8, filed on Dec. 5, 2013, all of which are herein incorporated by reference in their entireties.

### BACKGROUND

### 1. Field

This invention relates generally to verification techniques and devices; and, more particularly, to devices and methods for the verification of an individual's identity, possibly via the use of a Personal Identification Code (PIC). The invention is suited for use in situations where verification must be performed before access is granted to some type of controlled resource. It is particularly suited for use with mobile and/or handheld devices which are provided with telecommunications functionality, such as mobile phones, portable computing devices etc. It may also be used with, but not limited to, use in financial operations such as purchases, balance enquiries and so on. It may be used as a card reading payment terminal when a PIN must be checked.

### 2. Related Art

Chip cards (also known as ‘smart cards’ or ‘integrated circuit cards’ (ICCs)) have become ubiquitous in modern life. These are plastic cards which have integrated circuits on them to provide functionality for identification, authentication, data storage and application processing. Perhaps the most well-known examples include debit, credit and ATM (automated teller machine) cards; however, such cards are also used for other purposes such as for accessing non-financial resources and for gaining access to buildings.

While this document focuses upon the use of chip cards within a financial environment as the most well-known example, it is to be noted that the invention described and defined herein is not to be limited in this regard and other applications would fall within the scope of the invention. The invention may be used within commercial or non-commercial contexts.

A set of globally accepted standards, known as EMV, defines how interactions at the physical, electrical, data and application levels are conducted between the chip card and processing device (terminal) which ‘reads’ it during a financial operation. The cards and the terminals they are used with conform to these standards.

The terminals include card-reading capabilities and are connected to Point of Sale (POS) terminals which the retailer uses to record the relevant data during a sale. The customer's card is usually inserted into the terminal so that the data can be read from it, although it could alternatively be swiped through the device, or brought into close proximity with the terminal if a ‘contactless’ form of terminal is being used. Whichever technique is used, the data from the card is read (from the chip or magnetic stripe) by the terminal which then displays prompts and other messages for the user on a display or screen.

When a customer wishes to make a transaction, his identity needs to be established so that unauthorised use of the card is prevented. A common technique is to use a code which identifies the individual. In this document such a code may be referred to as a Personal Identification Code (PIC). One very common example of a PIC is a 4 digit code typically referred to as a Personal Identification Number (PIN). However, other codes of different lengths and containing different types of characters may be used. Essentially, the term ‘PIC’ can be used to refer to any type or form of identifier.

Most terminals provide PIN pads (also referred to sometimes as ‘keypads’) so that the user can enter their PIN for verification purposes. The PIN-based approach requires the user to pre-select a PIN (i.e. prior to starting the transaction/operation) which is electronically stored at the customer's bank or other institution. A copy of the PIN is also written to the memory provided on the card's chip.

The terminal is often provided with a PIN pad (or ‘keypad’) which has depressible keys. However, a touch screen could be used to display an image of a PIN pad, having numbered or otherwise indicated ‘hot spots’ corresponding to the physical keys of a conventional PIN pad. The user touches the hotspots corresponding to the keys of his choice instead of pressing a moveable key. Sensors placed below the surface of the screen sense which area(s) have been selected by the user, thus ‘reading’ the user's input. Thus, the touchscreen provides an electronic alternative to mechanical, depressible PIN pad.

When the user enters his PIN into the terminal's PIN pad, the entered PIN must be checked and compared against the pre-determined, stored PIN. If the PINs match, the user's identity is deemed to be verified and the transaction is allowed to proceed. If the entered and stored PINs do not match then the operation fails.

The point in the process where the PIN is checked, and by which party, dictates whether the authorisation process is known as an ‘offline’ or ‘online’ authentication, as will be explained below.

As well as processing the card details, allowing entry of the user's PIN and guiding the user through the process via a series of prompts, the card-reading terminal also stores what is known as the ‘session key’. The session key is a key which is loaded onto the terminal by the retailer's bank and is stored in the terminal in an encrypted form (typically using a data encryption algorithm known as Triple DES (or “3DES”). The key changes periodically, with each bank typically specifying its own time frame in relation to the duration or lifetime of the session key. Moreover, the session key may be different for each terminal, or the same for groups of terminals, or the same for all terminals.

In operation, the terminal reads the card data and requests the PIN number from the user (i.e. the customer, the person whose identity must be verified via to granting access to the controlled resource or funds).

The terminal then forms an encrypted message which includes the ‘session’ key and other transaction-related data (e.g. operation code, amount to be debited etc.) before transmitting this to the bank. Typically, the message is formed according to the ISO8583 standard (although not necessarily so, and other message formats may be used). ISO 8583 defines a message format and a communication flow so that different systems can exchange transaction requests and responses. The message is segmented into various fields which specify different parameters relating to the instruction or request.

When a transaction is to be made (or at least attempted), the terminal sends the ISO8583 message to the incoming (‘acquiring’) bank. There is a variety of networks which EFTPOS (electronic funds transfer at point of sale) transactions may be conducted over.

A computing resource (typically a server or distributed computing system) at the incoming (acquiring) bank verifies the incoming message from the terminal to check that it has been encrypted by one of its valid session keys. It then decrypts this message in a hardware security module (HSM) and re-encrypts it with the session key of the next bank in the transaction chain.

As mentioned above, transactions are often categorized into ‘offline’ or ‘online’ transactions. Certain countries often use one or the other exclusively or predominantly.

Offline Authorisation

FIG. 1 provides an overview of the current (known) offline authorisation process used in many countries. By way of example: a customer wishes to make a purchase at a retailer's premises (e.g. a shop). He presents his card for payment. The retailer enters the amount to be processed into the ePOS device (e.g. cash register) which transmits the amount to the payment terminal. Upon being prompted by an on-screen message, the customer inserts his IC card into the terminal. The data is read from the chip on the card into the EFTPOS terminal.

In response to a further prompt, the user enters his PIN using the PIN pad (or ‘key pad’) provided on the terminal. When the PIN is entered it is encrypted by the PIN pad component and is passed to the terminal's processor. The terminal then compares this encrypted PIN with the encrypted version that has been stored (and has been read from) the chip. If it is incorrect then the user is prompted again to enter his PIN and the process is repeated. After 3 incorrect (non-matching) PIN entries the terminal typically blocks the card (by setting a flag on the chip) and informs the issuing bank that this has occurred.

In the alternative, if a correct i.e. matching PIN is entered the terminal generates (for example) the ISO8583 message and encrypts it along with the acquiring bank's session key which has been stored on the terminal. A flag in the message is set to ‘yes’ to indicate that that the user's entered PIN has been checked and is correct. The terminal then sends this message via the EFTPOS network to the retailer's bank. The retailer's bank is otherwise known as the ‘acquiring bank’ or simply ‘acquirer’.

Upon receipt, the acquirer decrypts the message and sends it to the customer's bank for processing. The customer's bank is otherwise known as the ‘issuing bank’ or simply ‘the issuer’.

Upon receipt of this next message, the issuer transfers the amount of money specified in the message to the acquiring bank, subject to funds being available. Note: in some cases the operation may be reserved for processing later, and so the fund may not be transferred until a later time or date.

It is important to note that in ‘offline’ processing, neither the acquiring bank nor the issuing bank checks the PIN number because the message flag indicates that the PIN has already been checked and it was deemed to be correct. Therefore, no PIN needs to be sent via the message.

A message is then sent back from the issuing to the acquiring bank and then on into the terminal, to indicate whether the transaction has been successful or unsuccessful. If the operation was unsuccessful this would normally be due to insufficient funds. However, if the message from the issuing bank indicates that the card is identified as being stolen, a prompt on the terminal may instruct the retailer to keep the card.

At the end of the processing day, the funds are passed from the customer's account to the retailer's account less any amount charged by the acquiring bank e.g. 2.8%.

Therefore, in an offline transaction system the PIN verification is performed locally by the terminal, not remotely at a bank or the card issuing institution.

With reference to FIG. 1, the ‘offline’ approach can be summarised as follows:
1. Customer enters chip card into terminal.
   (The terminal reads the card data ie. Primary Account Number (PAN) and requests the user's PIN)
2. PIN is entered by the user via the PINPAD.
   (The customer is prompted by PINPAD for their PIN)
3. Terminal verifies PIN.
   (Entered PIN is encrypted by PINPAD and PIN compared against encrypted PIN stored on card. If PIN is not correct then the transaction is aborted)
4. Payment message is sent to acquiring bank.
   (If the PIN is correct then the terminal forms an ISO8583 message (or a message in accordance with another format/protocol) with the ‘PIN checked’ flag set to “yes”; the message is sent to the Acquirer for processing)
5. Message is sent to Issuer.
   The acquirer sends the message to the issuer and waits for a response.
6. An ‘Authorised/Not Authorised’ message is passed back to terminal.
7. An ‘Authorised/Not Authorised’ message is passed back to the customer.

Online Authorisation

‘Online’ transactions are conducted via an EFTPOS system in many countries. Sometimes verification is not required for values under a specified amount (e.g. a threshold of $100) but for transactions involving larger amounts verification is required and is then performed via an ‘online’ approach. The main difference with this approach and that described above is that in the online approach the local terminal does not check the PIN stored on the card but actually refers back to the issuing bank for validation. The PIN verification is performed remotely by the issuer.

Therefore, the online approach follows largely the same process as for the offline verification described above except that the ISO8583 message that is sent to the issuing bank has the ‘PIN Checked’ flag set to “NO” and an encrypted version of the PIN is included in the message. It is not performed locally by the terminal.

Upon receipt of the message the issuing bank checks that the PIN entered by the user at the terminal is correct and valid in the first instance and then, if valid, proceeds to process the transfer or other operation as above.

However, known problems exist in respect of the current systems.

For example, using the offline approach, if a third party could extract the bank's session key from the terminal he would be able to send false transactions to the acquiring bank where they would be automatically accepted. The acquirer would then transmit these fraudulent transactions to the issuing bank where they would also be accepted without query and, because the PIN checked flag is set to “yes”, they would automatically be processed. The money would be transferred, subject to available funds. Recall that the message does not include a PIN.

As a result of this, a set of guidelines issued by the Payment Card Industry (PCI) governs how the session key is physically protected inside the terminal. This, in turn, imposes a cost implication for terminal manufacturers. Terminals can therefore be costly, sometimes up to several thousand pounds per device. However, in some countries e.g. the UK, online verification is not available. Therefore, retailers have no real commercial option but to pay for the costly PCI compliant terminals if they want to be able to accept their customers' payment cards.

In addition, if the terminal were to be compromised, and there have been several known incidents where this is the case, the user's PIN would be accessible to unauthorised parties.

Therefore, encryption algorithms and other such techniques must be implemented within the terminal to provide the necessary protection. Again, this adds to the complexity and cost of the terminal.

### SUMMARY

Thus, it is desirable to provide a solution which:
Is secure and provides verification of the user's PIN without it being vulnerable to unauthorised access;
does not require a session key to be stored on the terminal, thus reducing the risk of session key theft, and reducing the cost of the terminal itself;
does not have the need for sensitive encryption keys;
provides an alternative to the current system in countries where online PIN verification is not available and retailers or other relevant parties have little choice but to pay for costly terminals.

Such an improved solution has now been devised.

Thus, in accordance with the present invention there is provided a device, system and corresponding methods as described herein and defined in the appended claims.

Therefore, in accordance with the invention there may be provided a portable PIC input device comprising:
a card reading component; and
a touch screen arranged and configured to display a pinpad and enable entry of a PIC by a user via the pinpad;
wherein the card reading component and the touch screen are integral to the input device.

Alternatively, the device may be referred to as a ‘terminal’. It may be referred to as a ‘card reading terminal’ or a ‘payment terminal’. Further still, it may be referred to as a ‘PIC capture device’. It may be an electronic device, and may be computer-implemented. The term ‘integral’ is used herein to mean that the card reading component and the touch screen are formed as essential components of the input device. They may be provided as forming one single device. This may be performed at the manufacturing stage. This distinguishes the invention over known arrangements wherein a card-reading dongle is connected to a mobile phone during use. By contrast with the prior art, the card reading component is supplied with or built into the device along with the rest of the components required to supply the terminal's functionality (e.g. telecommunications and transmission capabilities, processing capabilities, user input/output interfaces etc).

The screen may serve as both an input and an output mechanism. Thus, the screen may be used to display information such as prompts and virtual (i.e. non mechanical) pinpads. It may also be used by the user to input data into the device. Therefore, the device may not comprise mechanical, depressible keys. The screen may be divided into different sections or areas. All or part of the screen may be a touch screen. For example, the pinpad may be displayed in one area of the screen while prompts and messages may be displayed in a second area. The second area may or may not be touch responsive.

The screen may be configured to display an image (static or otherwise) of a keypad. The keypad image may be a representation of a scrambled keypad i.e. a keypad with keys in an unexpected or randomised order. Thus, instead of displaying characters in contiguous order such as 1, 2, 3, 4 etc., the ordering may be altered.

The device may be a mobile (cellular) smart phone having a built-in card reading arrangement.

The device may comprise software for generating a virtual keypad in a portion of memory. The device may be configured such that an operable keypad may be generated and/or displayed upon execution of some code e.g. a method call or procedure call. This may be provided as a portion of code within a library on the computer-implemented device.

The device is portable in the sense that it may be held by the user in one or both hands during use. It may be referred to as a ‘handheld’ device or a ‘mobile’ device. This may be in contrast to large, static devices such as ATM machines.

The device may comprise a processor arranged and configured to execute an operating system. Thus, the device preferably comprises processing capabilities. The processor may be supplied on a circuit board. The circuit board may be configured such that components can be connected to the data bus. The circuit board may be a mobile phone circuit board.

Preferably, the device comprises one or more components configured to enable transmission of the PIC to a destination. The device may be configured for wireless transmission of the PIC and/or other data. Additionally or alternatively, the PIC may be transmitted in an encoded or translated form. The destination may be a remote computing resource. The term ‘remote’ is used to mean that the computing resource is separate from the device and is not necessarily indicative of geographical distance. The device may be configured to transmit data via any wireless technology such as mobile telephone network, or the internet and/or Bluetooth™.

The device may be a payment terminal configured for use in a financial transaction process. Thus, the device may be used in a retail environment. The user may be a customer wishing to make a purchase.

Preferably, the device comprises a housing. One, some or all of the components may be completely or partially provided within the housing. Preferably, the card reading component is provided within the housing of the device. The card reading component may, therefore, be permanently provided in or on the housing. The housing may be formed so as to resemble a ‘conventional’ card payment terminal.

The device may comprise a processor arranged and configured to execute a mobile telephone operating system. The device may comprise mobile phone software and/or hardware.

Thus, in one sense the invention may be viewed as a card payment terminal comprising a housing, with at least some mobile phone functionality and a card reading arrangement being provided within or on the housing. The mobile phone functionality may at least comprise telecommunications and processing capabilities. The mobile phone functionality may comprise a camera.

Preferably, the invention may comprise a camera. This provides the benefit that a still and/or moving image of the user may be captured. The image may be recorded in memory. This may provide enhanced security as the identity of the person using the card can be verified or at least recorded using the image.

The data may be read from a card having a magnetic stripe, smart card chip, and/or RFID chip. The component which is arranged to read the data from the card may be a card reader, such as a DIP reader, a contactless smart card reader, or a magnetic card reader. The device may be configured to receive at least a portion of the card to enable the data to be read from the card. Thus, the user may insert all or part of the card into the device, or swipe it through the device, in order for the data to be read from the card.

Thus, the invention is not intended to be limited with regard to the type of card that the device can read from. The data may be read from a magnetic strip provided on the card, or from a chip. The card reading component may be a ‘contactless’ arrangement wherein data can be read from the card when it is brought into proximity with the invention.

Preferably, the device is not configured for compliance with EMV or PCI standards. Additionally or alternatively, the device is not configured for secure storage of a bank session key. This provides the benefit that the terminal can be manufactured without the costly security features required by known payment terminals. The invention provides a cheaper, simpler alternative to known PIC input devices.

Preferably, the invention also provides a security mechanism for protecting the user's PIC. With conventional card reading terminals, security measures are provided as part of the terminal's functionality, pushing up the price of the terminal. The terminal must include security features to prevent unauthorised access to the user's PIC in the event that the terminal itself is compromised (i.e. hacked into). As the present invention may, according to one possible choice of wording, be described as a mobile phone within a card-reading terminal, security measures may be needed to protect the user's PIC as mobile phones are inherently insecure devices.

Thus, the device may be arranged and configured to:

generate a PIN pad operable within a PIN pad zone of the screen; and

display an image of at least part of a scrambled PIN pad, the image being displayed, at least partially, within the PIN pad zone;

such that the user is able to enter the PIC by operating at least one key of the PIN pad via the image.

The operable keypad may be generated by a piece of code such as a method or procedure which, when executed, generates a virtual (i.e. non mechanical) keypad. It may create a keypad object in memory. The code may be part of a library.

Thus, the device may be configured to receive an image (static or otherwise) of at least a portion of a scrambled pinpad. The image may be received from a remote server. The device may comprise software configured such that, upon execution, an operable pinpad is generated in memory. The pinpad is operable in the sense that different portions of the pinpad are associated with respective keys such that when the user touches a given portion of the screen, the user's keystroke associated with that portion of the screen is recorded within the device. This operable pinpad may be ‘overlaid’ or superimposed by the image of the scrambled pinpad such that when the user touches the ‘1’ key in the image, for example, the operable keypad interprets the user's keystroke as something else e.g. ‘6’. The image is then deleted from the device's memory. Thus, the user's PIC may be inputted into the via the touch screen and encoded by the electronic device. This encoding is done without the need for complex or costly software. It is also done without the need for the user to remember a different code or pattern of keystrokes. Thus, this feature provides a security measure which is easy and intuitive for the user to use.

Preferably, the image does not change between each of the user's keystrokes but remains the same during input of the entire PIC. This distinguishes the invention over known systems which alter the screen after each of the user's keystrokes. Such an approach can be confusing for the user and less intuitive to use than the present invention.

Preferably, the invention does not record coordinates of where the user has touched the screen. Preferably, the system does not record or transmit screen-related coordinates. Instead, it may use the operable keypad which may be provided as a standard feature on the device e.g. mobile phone to generate an encoded PIC which is made up of symbols e.g. chars or numbers. This provides a less complex and processor-intensive solution than arrangements which involve recording and processing of coordinates.

As the user's ‘real’ PIC may never be entered into the memory of the device it is not possible for an unauthorised party to derive or access the user's intended input from the device itself. Thus, the invention provides a simple, low cost but secure alternative to conventional card payment terminals.

The invention also provides an authentication system comprising a device as described above, in any form or configuration.

The invention also provides a method of manufacturing a handheld PIC input device, the method comprising the steps of:
providing a card reading component; and
   providing a touch screen arranged and configured to display a pinpad and enable entry of a PIC by a user;
   wherein the touchscreen and the card reading component are provided within or on a housing.

The method may further comprise the step of providing mobile phone software and/or hardware within the housing. Thus, in one sense, the invention may be viewed as incorporating a mobile phone and a card reading arrangement into a single device. The device may comprise a housing within or on which the phone and the card reader are provided. The housing may be formed to resemble a conventional card reading terminal.

The invention also provides a PIC authentication method corresponding to use of the PIC input device as described above. Thus, the method may comprise the steps of:
reading data from a card inserted into a payment terminal;
enabling a user to input a PIC via a screen provided on or in the payment terminal; sending the PIC and/or other data to a destination.

Thus, the invention may be viewed as providing a verification tool or technique for use in a PIC authentication process. It may be viewed as a PIC capture device. The authentication of the PIC may not be performed by, in or on the device itself. The PIC may be verified (authenticated) by a computing resource which is located remotely from the device. The device may be in wired or wireless communication with the remote computing resource.

The PIC may be a PIN or any type/form of identifier associated with a person or plurality of persons. The PIC may be used to manage access to any type of (financial or non-financial) resource.

The PIC may be a sequence of characters. The PIC may comprise any number and/or type of characters. A character in a PIC may be a numeric digit, or an alphanumeric character, or any other symbol (indicia). A PIC may be referred to as a ‘PIN’ and vice versa. The term ‘identifier’ may also be used interchangeably with ‘PIC’ or ‘PIN’.

Therefore, in this document the terms ‘PIN’ or ‘PIC’ are used not only to refer to personal identifiers which contain solely 4 numeric digits. The invention is not to be construed as being limited to the number or type of characters which are used to form the PIC.

Similarly, the term ‘PIN pad’ should not be construed in this document as being limited in some way to the type or number of symbols/keys which are presented to the user. The term ‘key pad’ may be used instead of ‘PIN pad’. Essentially, the PIN pad is a component which allows the user to enter his input into the terminal or phone for subsequent transmission and/or processing.

Thus, according to an alternative form of wording, the invention may be described as an electronic device comprising:
a card-reading component arranged and configured to read data from an integrated circuit card;
a touch screen arranged and configured to display a PIN pad and read a PIC from the screen upon entry of the PIC by user via the PIN pad.

Preferably, the device is, or at least visually resembles, a payment card terminal. Preferably, the device is a mobile phone.

Preferably, the device is arranged and configured to display at least two PIN pads, wherein a first PIN pad is superimposed over a second PIN pad such that the second PIN pad is at least partially obscured from view by a user of the device. The second PIN pad may be an operable PIN pad i.e. it has the expected functionality of a PIN pad in that it enables a user's input to be received and stored in the device. The first PIN pad may be an image or respresentation of a PIN pad i.e. it is not an operable PIN pad in that touching the image will not, in itself, cause the device to receive some input.

Preferably, the device is arranged and configured to construct an encoded version of the user's entered PIC.

Preferably, the position of at least one indicia or symbol in the first PIN pad is different from the position of the same indicia or symbol in the second PIN pad. Thus, the position of the ‘keys’ in the first PIN pad (i.e. the image) may be scrambled relative to the position of the operable keys in the device's underlying, default PIN pad.

Preferably, the device is arranged and configured such that when the user presses a key (i.e. selects a symbol) on the first PIN pad the device records the indicia/symbol of the key at the corresponding position in the second PIN pad. In other words, the user touches an image of a key at a location on the screen, but the input received and stored by the device is dictated by the key at that location in the underlying, operable PIN pad.

Thus, the PIC which is constructed by the device from the underlying, second PIN pad may not be the same as the PIC which the user believes he has entered using the first, overlaid PIN pad image.

The device may be arranged and configured to further encrypt the encoded PIC.

The device may be arranged and configured to read data from a card. The card may be an integrated circuit card. Additionally or alternatively, the data may be read from the card from a magnetic strip. The device may be arranged and configured to send the data to a remote server (or other electronic device) with or without the user's encoded PIC.

The device may be arranged and configured to form part of an on-line and/or offline financial transaction or payment system.

The device may be constructed such that it does not comprise a bank session key.

The features described above may be present in any or all embodiments of the invention.

These and other aspects of the present invention will be apparent from, and elucidated with reference to, the embodiment described herein.

An embodiment of the present invention will now be described, by way of example, and with reference to the accompanying drawings.

### BRIEF DESCRIPTION OF THE DRAWINGS

FIG. 1 illustrates the prior art process of verification as occurring in an ‘offline’ verified transaction.

FIG. 2 illustrates a process in which an embodiment of the present invention may be utilised.

FIG. 3 illustrates a card reading payment terminal in accordance with the present invention.

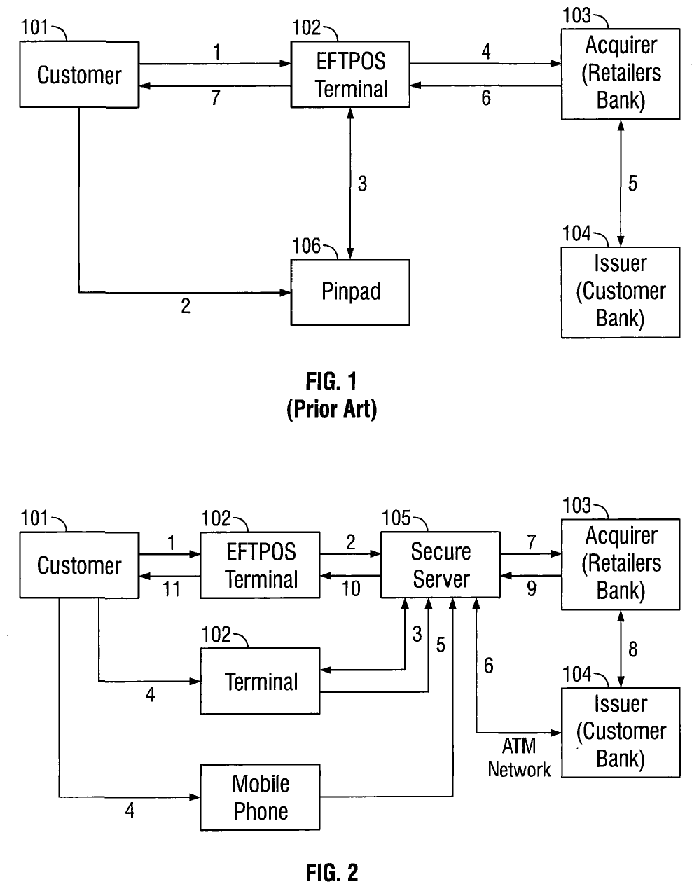

### DETAILED DESCRIPTION

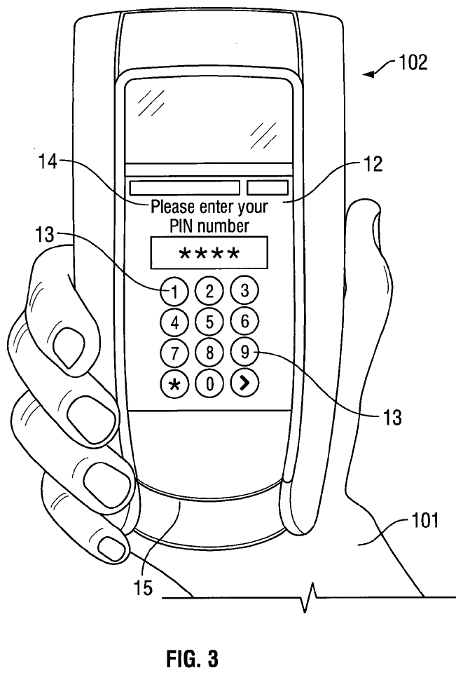

FIG. 3 shows an illustrative embodiment of the present invention. The invention provides a PIN capture device 102. It is configured such that it can be held in one or both hands by the user 101 as shown. The terminal 102 looks like a conventional PCI compliant terminal in all respects except that internally it does not have the ability to securely store a bank session key. The terminal has a touch screen 12 which is able to display a virtual keypad comprising a plurality of keys 13. The screen is also able to display messages and prompts 14 as well as read input from the user 101 when the user presses a key 13. The terminal has a card reading arrangement 15. In FIG. 3, this is shown as a slot or recess into which a payment card with a chip may be inserted. A contactless card reader may be used in addition to or as an alternative to the slot, as may a magnetic strip reader.

In an embodiment of the invention, when a customer wishes to make a transaction at a retailer's premises the retailer captures the transaction details via the ePOS device and these details are sent to the terminal (as described above). The terminal is a device configured in accordance with the present invention.

The customer (user) 101 enters his chip card (ICC) into the terminal 102 via the slot 15 so that the required data can be read from the card.

The terminal 102 has a PCI approved chip or swipe card reader component 15 and a screen. The card reading component is integrally formed with the terminal in that it is supplied as an intrinsic component when the terminal is assembled. The card reading component is not a plug-in or add-on device such as a dongle.

The screen can be used to display prompts 14 to the customer and can also be used for PIN entry. In other words, the terminal has a touch screen rather than a mechanical PIN pad with physically depressible and moveable keys.

The customer's card details are sent from the terminal 102 to a remote, secure server 105. The term ‘remote’ is used to mean that the server is distinct from the terminal and is not indicative of any particular geographical distance.

The user 101 is prompted for his PIN. In a preferred embodiment, the PIN entry is then performed in such a manner that the user's input is effectively encoded via the PIN pad during the entry process. It is never entered or stored in its ‘raw’, un-encoded form into the the terminal. It is never stored inside any memory (buffers) within any component of the device. Therefore, the user's un-encoded PIN cannot be accessed inappropriately from the terminal, neither does it need to be encrypted by the terminal—although it could be subsequently encrypted in some embodiments so as to further enhance security.

This reduces the complexity and cost of the terminal while preserving security of the PIN.

It is noted that other embodiments may be devised which do not encode the user's input in this way or, indeed, in any way at all. It is also noted, though, that in the context of financial operations the protection of data is of the utmost importance and any embodiments which could lead to its compromise or unauthorised access may be considered as being less advantageous than the preferred embodiment described herein.

As the user enters his PIN, a symbol may be displayed per keystroke. This symbol may be an asterisk * for example. This indicates to the user how many keystrokes have been entered without displaying the actual keystroke recoded by the device.

In the preferred embodiment of the invention, the secure PIN entry is performed as follows.

Upon receipt of the card details, a representation of a PIN pad is sent from the secure server to the terminal, to be used in capturing the user's PIN entry. The server 105 retains the card details.

The PIN pad which is sent to the terminal is a graphical representation i.e. image of a ‘normal’ operable PIN pad but the positions of the keys are scrambled. Therefore, the ‘1’ on the scrambled PIN pad may appear in the position where the ‘6’ key would normally be provided or expected.

An advantage of using a graphical representation of a PIN pad is that an image is not vulnerable to being ‘hacked’, ‘sniffed’, intercepted or otherwise compromised in the same way that other types of data may be.

A procedure or method is executed by the terminal to generate an operable PIN pad. This operable PIN pad comprises keys and the functionality expected with a conventional keypad e.g. the ability to recognise when a key has been pressed and read the associated symbol into a portion of memory. The keys on the operable keypad are arranged in the expected manner e.g. numeric keys are in ascending or descending order.

Upon receipt of the randomized PIN pad image, the terminal superimposes this scrambled PIN pad over the top of the ‘regular’ operable PIN pad which has been generated at run time. In other words, the scrambled PIN pad image is overlaid on top of the underlying PIN pad of the terminal which has the keys provided in the conventional layout. If the image was not displayed, the operable PIN pad would be visible to the user and would be functional.

As far as the customer is concerned, there is only one PIN pad as all he sees is the scrambled version i.e. the image. This superimposition is achieved by displaying the image in the same area or zone of the screen that is associated with the operable keypad.

The user presses the ‘keys’ corresponding to his PIN using the scrambled PIN pad image displayed on the touch screen.

As the scrambled PIN pad has been superimposed over the terminal's operable PIN pad, the user's input is interpreted differently by the underlying operable PIN pad. Each ‘key’ on the scrambled PIN pad image forms a ‘hotspot’ which, when touched/pressed by the customer 101, effectively touches/presses the operable key beneath it. Therefore, the user might believe that he is pressing the ‘1’ key but as far as the terminal 102 is concerned he has touched the ‘6’ key and it is this underlying version of the input that is used to build up the user's encoded PIN within a buffer.

Therefore, the use of an overlaid, scrambled PIN pad image provides a means of encoding the user's input upon entry (or while it is being entered) rather than after it has been entered. As the real PIN is never stored inside the device 102 it can never be compromised within the device.

A mobile phone may be used in addition to or instead of the terminal described above. In such an embodiment, the phone would be a smart phone having a touch screen and capable of displaying the scrambled and default PIN pads and reading the user's input. The phone may comprise a camera so that images of the user 101 can be captured for enhanced security.

The phone may be a conventional smart phone with the addition of a built-in card reader. Therefore, some implementations of the invention may be viewed as the integration of a prior art dongle into a smart phone.

In some other implementations, the invention may be viewed as essentially a smart phone within a box or housing, the housing comprising a card reader and configured to resemble a conventional card payment terminal.

Details pertaining to the generation, transmission, appearance and formation of the scrambled PIN pad may vary; but in some embodiments the server may pre-generate a set of randomized PIN pad images which are stored in association with the customer 101, and then a new PIN pad is selected from that set each time a transaction is to be performed. ‘Used’ PIN pad images can be removed from the set, and ‘undesirable’ images (e.g. those with keys in a sequence which may be easier to guess) can be deleted from the set so that they are never used. In such ways, the security of the system may be enhanced. However, the skilled addressee will understand that variations of this approach may be used while still falling within the scope of the claimed invention.

Once the user's encoded PIN has been constructed within the terminal 102, it is sent by the terminal to the remote, secure server 105 and is deleted from the terminal's memory. It is encrypted prior to this transmission, but if it is intercepted it is only of use to an unauthorised party if they also know the mapping of the ‘normal’ PIN pad keys to the scrambled PIN pad (and this information is only held on the server).

Once the encoded PIN is received at the server, it can be decoded because the server ‘knows’ which scrambled PIN pad layout was used by the customer. In effect, the mapping is reversed to provide a decoded version of the customer's real PIN.

The server then uses known techniques, encryption algorithms and so on to form a message which includes the card details, the PIN and an operational request.

Referring to FIG. 2, an embodiment of the invention in use can be expressed as follows:
1. Customer 101 enters chip card into terminal 102.
   (Terminal or phone 102 reads the card data ie. PAN, and requests the user's PIN)
2. The card data is passed to the secure remote server 105.
   (The cardholder's data that has been encrypted at source by the PCI approved chip or swipe reader is passed to the remote server 105)
3. Pin Pad is requested/sent
   (a virtual, scrambled PIN pad image is requested by the terminal/phone 102 and sent from the server 105 to the terminal or mobile phone)
4. PIN entered.
   (Customer is prompted by terminal or mobile phone for their PIN)
5. Encrypted PIN sent.
   (The entered PIN has been self-encrypted by the PIN pad and is further 3DES encrypted, then sent from the terminal/phone 102 to the remote server 105)

Thus, the present invention provides at least the following advantages:
it is secure and provides verification of the user's PIN without it being vulnerable to unauthorised access;
it does not require a session key to be stored on the device i.e. phone/terminal (thus reducing the risk of session key theft, and reducing the cost of the terminal itself); a terminal which does not need a session key does not need to comply with PCI requirements;
it avoids the need for sensitive encryption keys as the PIN pad of the terminal self-encrypts the user's PIN upon entry without actually needing to apply an encryption algorithm;
The invention is highly advantageous and relevant for use in countries such as the USA where there is a need to deliver EMV security with minimal changes in hardware. The cost to move to an offline Chip and PIN system in the US has been estimated to be in the tens of billions of dollars.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A portable PIC input device comprising:
a card reading component; and
a touch screen arranged and configured to display a pinpad and enable entry of a PIC by a user,
wherein the card reading component and the touch screen are integral to the input device.

2. A device according to claim 1, wherein:
the device comprises a processor arranged and configured to execute an operating system.

3. A device according to claim 1, wherein:
the device comprises one or more components configured to enable transmission of the PIC to a destination.

4. A device according to claim 1, wherein:
the device comprises at least one of:
i) a payment terminal configured for use in a financial transaction process; and
ii) a mobile phone.

5. A device according to claim 1, wherein:
the device comprises a housing, and at least one of the components are at least partially provided within the housing.

6. A device according to claim 1, wherein:
the device comprises a processor arranged and configured to execute a mobile telephone operating system.

7. A device according to claim 1, wherein:
the device comprises mobile phone software and/or hardware.

8. A device according to claim 1, wherein:
the device comprises at least one of:
i) a camera; and
ii) a mobile phone comprising: telecommunications capabilities and a camera.

9. A device according to claim 1, wherein:
the data is read from a card having at least one of a magnetic stripe, smart card chip, and RFID chip.

10. A device according to claim 1, wherein:
the component which is arranged to read the data from the card is a card reader, wherein the card reader is a DIP reader, a contactless smart card reader, or a magnetic card reader.

11. A device according to claim 1, wherein:
the device is not configured for compliance with EMV or PCI standards; and/or
the device is not configured for secure storage of a bank session key.

12. A device according to claim 1, wherein:
the device is configured for wireless transmission of the PIC and/or other data.

13. A device according to claim 1, wherein:
the device is configured to receive at least a portion of the card to enable the data to be read from the card.

14. A device according to claim 1, wherein:
the device is arranged and configured to:
generate a PIN pad operable within a PIN pad zone of the screen; and
display an image of at least part of a scrambled PIN pad, the image being displayed, at least partially, within the PIN pad zone such that the user is able to enter the PIC by operating at least one key of the PIN pad via the image.

15. (canceled)

16. A method of manufacturing a handheld PIC input device, the method comprising:
providing a card reading component; and
providing a touch screen arranged and configured to display a pinpad and enable entry of a PIC by a user,
wherein the touchscreen and the card reading component are provided within or on a housing.

17. A method according to claim 16, further comprising:
providing mobile phone software and/or hardware within the housing.

18. A PIC authentication method comprising:
reading data from a card inserted into a payment terminal;
enabling a user to input a PIC via a screen provided on or in the payment terminal; and
sending the PIC and/or data to a destination.

19. An electronic PIC capture device comprising:
a card-reading component or a connection arrangement to connect the device to a card-reading component, the card reading component being arranged and configured to read data from a card; and
a touch screen arranged and configured to display a PIN pad and read a PIC from the screen upon entry of the PIC by user via the PIN pad.

20. An electronic device according to claim 19, wherein:
the device is a mobile phone or an EFTPOS terminal.

21. An electronic device according to claim 19, wherein:
the device is arranged and configured to display at least two PIN pads, wherein a first PIN pad is superimposed over a second PIN pad such that the second PIN pad is at least partially obscured from view by the user.

22. An electronic device according to claim 21, wherein:
the device is arranged and configured to construct an encoded version of the user's entered PIC.

23. An electronic device according to claim 21, wherein:
the position of at least one indicia in the first PIN pad is different from the position of the same indicia in the second PIN pad.

24. An electronic device according to claim 23, wherein:
when the user presses a key on the first PIN pad the device records the indicia of the key at the corresponding position in the second PIN pad.

25. An electronic device according to claim 19, wherein:
the device is arranged and configured to further encrypt the encoded PIC.

26. An electronic device according to claim 19, wherein:
the device is arranged and configured to read data from an integrated circuit card and send this data to a remote server with or without the encoded user's PIC.

27. An electronic device according to claim 19, wherein:
the device is arranged and configured to form part of an on-line and/or offline financial transaction or payment system.

28. An electronic device according to claim 19, wherein:
the device does not comprise a bank session key and/or is not configured to receive a bank session key.
